(19) United States
(12) Patent Application Publication
(10) Pub. No.: US 2018/0283864 A1
(43) Pub. Date: Oct. 4, 2018

(54) Field Slope Angle Tool And Trenching Method

(71) Applicant: Christopher Bryan West, Peachtree City, GA (US)

(72) Inventor: Christopher Bryan West, Peachtree City, GA (US)

(21) Appl. No.: 15/783,513

(22) Filed: Oct. 13, 2017

Related U.S. Application Data
(60) Provisional application No. 62/430,978, filed on Dec. 7, 2016.

(51) Int. Cl. G01C 15/12

(52) U.S. Cl. CPC G01C 15/12; E02F 9/261

(57) ABSTRACT

The inventive concept presented is a trench slope angle tool and the method for using the slope angle tool during the excavation of a trench in a particular type of soil. In essence the slope angle tool is a planar, hand-held sighting device having a handle integrally attached to a Y-shaped component. The device may be utilized by a construction worker or project supervisor (the “user”) at a trenching worksite. The user visually superimposes the slope and banks of the trench against the contours of the slope angle tool to determine compliance with government-regulated excavation standards. Other important construction safeguards and govemmentally-regulated standards are also displayed on each face of the slope angle tool. In this manner, the correct trench sidewall slope, “spoil” pile locations, and other safety requirements can be readily observed to determine whether these elements are in compliance with the governmental regulations.

### CROSS-REFERENCES TO RELATED APPLICATIONS

This patent application claims the benefit of priority from previously-filed U.S. provisional patent application, Ser. No. 62/430,971, filed on Dec. 7, 2016, and further, claims the benefit of content of said provisional application as though fully appearing herein.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### BACKGROUND OF THE INVENTION

### (1) Field of the Invention

The inventive concept is relevant to trenching and excavation projects. Excavating is recognized as one of the most hazardous construction operations engaged in by workers, both in the United States and in other countries around the world. In the United States, the Occupational Safety and Health Administration (OSHA) has published regulatory information for this field of industrial work, which reads, in part: “revised Subpart P, Excavations, of 29 CFR 1926.650. 29 CFR 1926.651, and 29 CFR 1926.652 to make the standard easier to understand, permit the use of performance criteria where possible, and provide construction employers with options when classifying soil and selecting employee protection methods.”

The Occupational Safety and Health Administration (OSHA) defines an excavation as “any man-made cut, cavity, trench, or depression in the Earth's surface formed by earth removal. A trench is defined as a narrow excavation (in relation to its length) made below the surface of the ground. In general, the depth of a trench is greater than its width, but the width of a trench (measured at the bottom) is not greater than 15 feet (4.6 m).” Trenching and Excavation Safety; U.S. Department of Labor; OSHA 2226-10R-2015.

### (2) Description of the Related Art, including information disclosed under 37 CFR 1.97 and 1.98.

U.S. Pat. No. 6,336,077 (Jan. 1, 2002). An automatic monitoring and display system for use with a digging machine in order to excavate holes having a predetermined depth and an excavation slope pitch from ground level to hole depth. The machine has a boom, a dipper stick connected to the boom and a bucket at the end of the dipper stick, all interconnected by three pivots. Only two sensors are used to detect the position of the bucket relative to a zero reference signal which is stored in a processor. The operator of the machine has a console whereby to select an excavation depth as well as a slope pitch angle and the console will display to him the hole depth and the percentage pitch on the slope as the excavation proceeds. The operator can reset his zero reference signal at any time from anywhere.

U.S. Pat. No. 5,933,346 (Aug. 3, 1999). A method is disclosed for controlling the cutting depth and angle of an excavator bucket to excavate a surface to a desired contour. The method includes the steps of: (1) inputting data to a machine control system to define a desired contour of the excavated surface; (2) positioning the excavator bucket close to the desired contour; (3) enabling automatic control; and (4) automatically controlling movement of the excavator bucket only when the position of the excavator bucket is within a predetermined distance or angle of the desired contour. The method is used to automatically control the excavation to a desired depth if the bucket is within a predetermined distance of a desired depth. The method is also used to automatically control the angular orientation of bucket if the slope of the bucket is within a predetermined angle of a desired slope.

U.S. Pat. No. 7,532,9676. (May 12 ,2009) The invention is intended to provide an excavation teaching device for a construction machine which can realize easy confirmation of a proper target excavation surface and increase the working efficiency during excavation even in work of forming the face of slope in complicated three-dimensional landforms. A display unit (46) displays, as an image in a first screen area (46a), a plurality of small plane surfaces G constituting a three-dimensional target land-form and illustrations of a body S of the construction machine and a bucket B as an excavating tool at a fore end of an operating mechanism.

U.S. Pat. No. 6,076,029 (Jun. 13, 2000). A slope excavation control system for a hydraulic excavator and a slope excavation method using a hydraulic excavator include an external reference 80 which extends horizontally in the direction of advance of a target slope face. A vertical distance hry and a horizontal distance hrx from the external reference to a reference point on a target slope face, and an angle of the target slope face are set by using a setting device. When a front reference provided at a bucket end is aligned with the external reference and an external reference setting switch is depressed, a control unit calculates a vertical distance hfy and a horizontal distance hfx from a body center of the excavator to the external reference, then calculates a vertical distance hsy and a horizontal distance hsx from the body center to the reference point of the target slope face by using the distances hsy and hsx as modification values. The control unit then sets the target slope face on the basis of a body of the excavator from the distances hsy and hsx and the angle input by the setting device, thereby carrying out area limiting excavation control.

### BRIEF SUMMARY OF THE INVENTION

The device and method disclosed in the inventive concept presented is a trench slope angle tool 1 which is intended to be used to ensure the safety of persons who perform the physical work of construction trenching and excavation.

The device disclosed in the inventive concept presented is a sighting device that functions as a trench slope angle tool 1. There is further disclosed a method for using the slope angle tool 1 during the excavation of a trench in a particular type of soil. In essence, the slope angle tool 1 is a handle integrally connected to a Y-shaped component, which constitutes a hand-held sighting device that may be utilized by a construction worker or project supervisor at a trenching worksite.

The user visually superimposes the slope and banks of the trench against the contours of the slope angle tool 1. In this manner, the correct trench slope, “spoil” pile locations, and other construction requirements can be readily observed to ascertain whether these elements are in compliance with OSHA standards, or excavation standards in other nations. When considering international projects, a similarly-modified slope angle tool 1 may be designed and constructed having instructions, slope angles, and precautionary procedures applicable to specific governmental standards in any country worldwide.

### BRIEF DESCRIPTION OF THE VIEWS OF DRAWINGS AS EXEMPLARY EMBODIMENTS OF THE INVENTIVE CONCEPT

FIG. 1 is a general graph depicting the slope of the gradation of a trench which generally conforms to OSHA standards.

FIG. 2 is a view of a face 12 of the Y-shaped component of the Field Slope Tool 1 configured for constructing a trench with a 34° slope angle in Type C soil.

FIG. 3 depicts the Slope Angle Tool 1 superimposed against the resulting trench 31 of an excavation project.

Table of Nomenclature & Part Numbers of Invention

| | |
|---|---|
| 1. | Field Slope Tool |
| 2. | Handle |
| 3. | Left vertical edge |
| 4. | Right vertical edge |
| 5. | Left wing |
| 6. | Right wing |
| 7. | V-bottom |
| 8. | Left lower edge |
| 9. | Right lower edge |
| 10. | Left upper edge |
| 11. | Right upper edge |
| 12. | Face |
| 13.-19. | n/a |
| 20. | Tool width |
| 21. | Wing height |
| 22. | Handle length |
| 23. | Spoil pile instructions |
| 24. | Exposed ladder length |
| 25. | Ingress/egress depth |
| 26. | Shoring/sloping depth |
| 27. | Maximum slope angle |
| 28. | Ratio height/depth |
| 29. | Soil type limitation |
| 30. | Spoil pile distance |
| 31. | Trench |
| 32. | Trench right sidewall |
| 33. | Trench left sidewall |
| 34. | Trench bottom |
| 35. | Trench depth |
| 36. | Trench shoulder |
| 37. | Spoil pile |
| 38. | Excavator |
| 39. | Excavator bucket |

### DETAILED DESCRIPTION OF THE INVENTION

The device and method disclosed in the inventive concept presented is a trench slope angle tool 1 and the method for using the slope angle tool 1. The device and method are intended to be used in combination, so as to comply with excavation safety regulations which are mandated by various governmental regulatory agencies in different countries.

By way of example only, and for illustrative purposes, the device and methods featured in this disclosure will focus primarily on the safety requirements mandated by the United States of America Occupational Safety and Health Administration (OSHA). In particular, the device and method set forth are intended to enhance the safety of workers who perform the physical work of construction of trenches at worksites.

On projects involving trenching work, the employer must have a competent person classify soil and rock deposits as:

(a) stable rock,

(b) Type A soil—“cohesive soils with an unconfined compressive strength of 1.5 tons per square foot (tsf);

(c) Type B soil—cohesive soil with an unconfined compressive strength greater than 0.5 tsf, but less than 1.5 tsf;

(d) Type C soil—principally, cohesive soil with an unconfined compressive strength of 0.5 tsf or less, which includes granular soils, and submerged soil or rock from which water is freely seeping.

Trenching jobs must be pre-planned and approached with care so as to prevent mistakes in shoring or sloping the project. An employer must take care to prevent injury to workers by sloping and, if necessary, benching the sides of the excavation. OSHA standards recommend sloping the sides of a trench to an angle not steeper than 1.5:1. Slope of this gradation is safe for any type of soil.

The objects, features, and advantages of the inventive concept presented in this application are more readily understood when referring to the accompanying drawings. The drawings, totaling three figures, show the basic components and functions of embodiments and/or methods of use. In the several figures, like reference numbers are used in each figure to correspond to the same component as may be depicted in other figures.

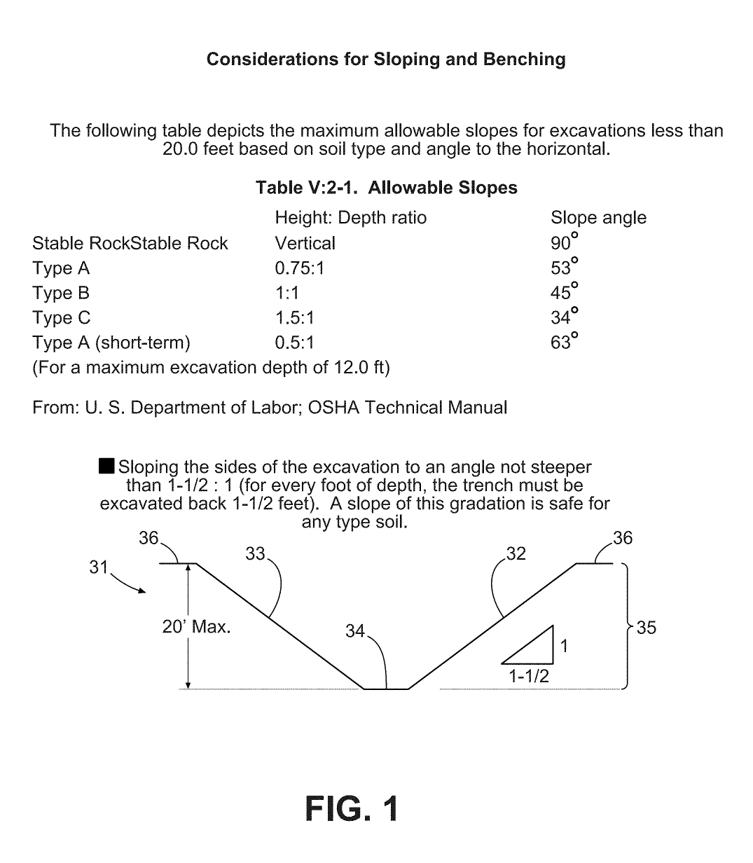

The discussion of the present inventive concept will be initiated with FIG. 1, which illustrates a schematic diagram of a trench based on a slope gradation of 1.5:1.Further shown in FIG. 1 is the trench left sidewall 33, the trench bottom 34, and the right sidewall 32. The left and right shoulders 36 are used for the deposits or “piles” of the excavated material, termed the “spoil pile” 37. When constructing a trench 31, the normal profile is defined as a narrow (width of trench in relation to its depth) excavation made below the surface of the ground. In general, the depth 35 of a trench 31 is greater than its width.

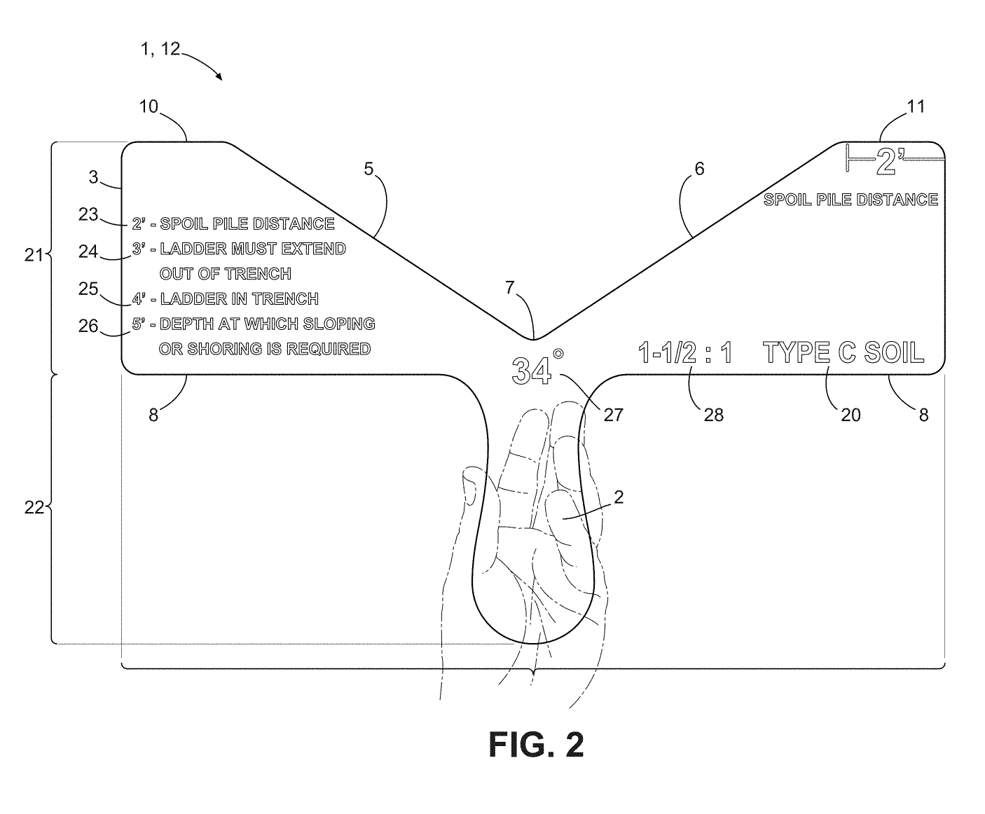

FIG. 2 depicts the view of one face 12 of the inventive concept, slope angle tool 1 (the “Tool” 1) as seen by a user of the Tool. A first face and a second face 12 on opposite sides of the Y-shaped component of the Tool 1 contain the same imprints as seen in FIG. 2. Before applying the method of use of the Tool 1, a decision will have previously been made by an engineer, construction supervisor, or other qualified person at the worksite as to a determination of the type of soil to be excavated. FIG. 2 depicts a Tool 1 designed, constructed, and containing imprinted advisory information for use in excavating a trench in Type C soil. Different embodiments of the Tool 1 are constructed with varying angles of the Y-shaped component and imprinted information corresponding to use of the Tool 1 with soil other than Type C.

FIG. 2 illustrates the basic components of the Tool 1, as seen looking at one face 12 of the Tool 1. Shown are a handle 2 which is connected to a Y-shaped component having a left wing 5, a right wing 6, a left vertical edge 3, a right vertical edge 4, a V-bottom 7, a left horizontal guide 8, a right horizontal guide 9, a left upper edge 10, and a right upper edge 11. Permanently imprinted on both faces of the Y-shaped component of the Tool 1 is information relevant to the use of the Tool 1 and the safety considerations required. These considerations include the OSHA-mandated spoil pile instructions 23, the OSHA-mandated exposed ladder length 24, the OSHA-mandated immersed ladder length 25, the sloping/shoring depth 26, the maximum allowable slope 27 in degrees, the slope ratio 28, the soil type limitation, 29, and the spoil pile distance 30.

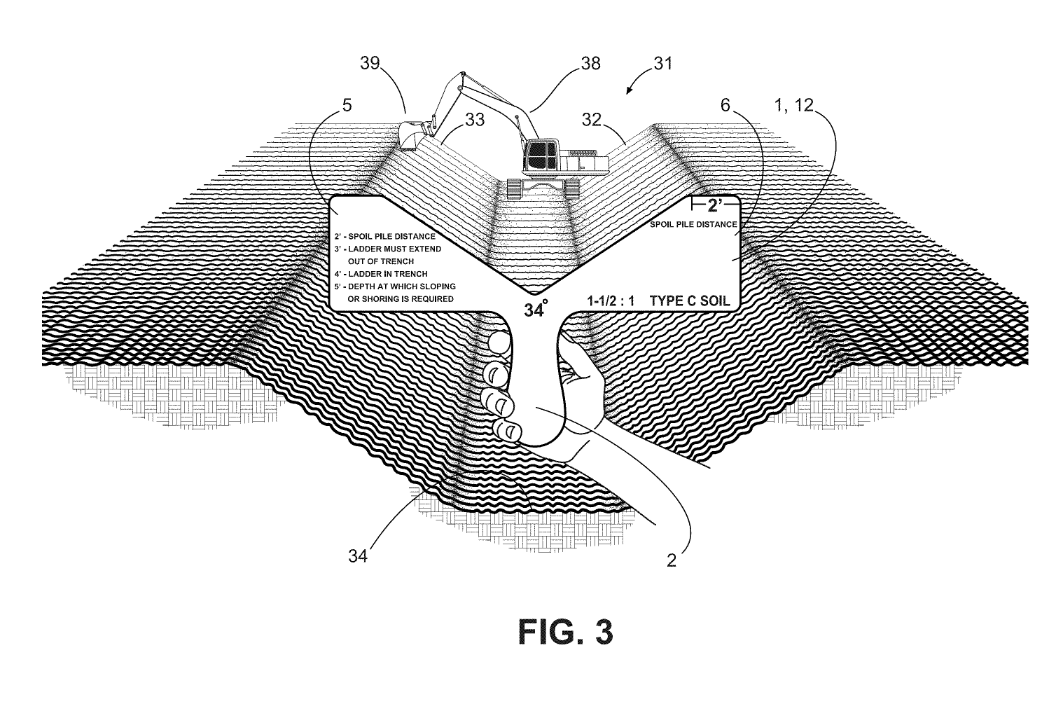

For purposes of illustration only, the following description of the inventive concept will hypothesize that the Tool 1 is to be utilized under conditions of Type C soil at a worksite. The theoretical worksite involves excavation of a trench 31. In practical application of the Tool 1 at the worksite, a worker or constructor supervisor (the “user”) grasps the handle 2 and positions him/herself standing in the trench bottom 34. This situation is illustrated in FIG. 3, where the user sights horizontally along a dug-up portion of the length of the trench 31. The user holds the Tool 1 at arm's length then adjusts the position of the Tool 1 so as to visually project the V-bottom 7 indentation of the Tool 1 onto the bottom 34 of the trench 31 at a location approximately twenty feet in front of the user. The user further orients the left lower edge 8 and the right lower edge 9 of the Tool 1 to be parallel with the Earth's horizon.

The left upper edge 10 and the right upper edge 11 are utilized to help locate the spoil distance along the left and right shoulders of the trench 31. As the user holds the Tool 1 level, the desired slope of the trench 31 is verified as a comparison is made with the slope of the left wing 5 and the slope of the right wing 6 of the Tool 1. It is imperative that the correct embodiment of the Tool 1 be used to correspond with the type of soil being excavated. As stated before, FIG. 2 demonstrates usage of an embodiment of the Tool 1 for use only with excavations of Type C soil. The allowable slope 27 for Type C soil is 34 degrees, as mandated by OSHA, (ref. FIG. 1) and as shown on the Tool 1 of FIG 2. The allowable slope is measured as the angle between the left lower edge 8 and the left wing 5, or similarly, the angle between the right lower edge 9 and the right wing 6.

The Tool 1 can be manufactured in different embodiments, depending on the type of soil 29 to be excavated. In each embodiment of the Tool 1, the angle of the slope of the left wing 5 and right wing 6 must be measured and fabricated to conform with the type of soil for which use of the Tool 1 will be applied for confirmation of the excavation standards. The relationship of the dimensions of the wing height 21, the handle length 22, and the Tool 1 width 20 may be varied as necessary. In referring to FIG. 2, the slope of both the left wing 5 and the right wing 6 can be 90, 63, 53, 45, or 34, degrees for different embodiments of the Tool 1, depending on the mandatory OSHA standards. For illustrative purposes, a slope angle of 34 degrees is indicated on the Tool 1 shown in FIG. 2.

FIG. 2 also sets out other important functions of the Tool 1 which are shown by the placement of imprints on each face 12 of the Tool 1. These imprints provide reminders and guidance to the user concerning specific requirements of the type of soil 29 at the construction site. These items of guidance and safeguards are depicted with respect to the embodiment of the Tool 1 used to guide excavation of a trench 31 in Type C soil, as follows:

A. the actual minimum clearing distance, or spoil distance 30, from the left and right shoulders 36 (ref. FIG. 1) of the trench 31, upon which spoil piles must be placed;

B. the height above the shoulders 36 of the trench 31 of which a minimum ladder length 24 must be exposed;

C. the ingress/egress depth 25 of a trench at which insertion of a ladder into a trench 31 is mandatory;

D. the depth 26 of a trench at which “sloping or shoring” of the trench is required;

E. the maximum allowable slope angle 27, in degrees of both sidewalls of the trench;

F. the ratio 28 of the height of a trench 31 to its width, as applicable to the type of soil being excavated;

G. the limitation 29 as to the soil type for which the Tool 1 may be used to gauge and verify the proper trench construction elements; and

H. the guideline as to the distance 30 from the edge of the shoulders of a trench at which spoils, or excavation materials, may be piled.

FIG. 3 illustrates a stylized rendering of the use of the Tool 1 on a trench 31 at an excavation site. A worker or supervisor (the “user”) is depicted holding the Tool 1 while standing in the trench bottom 34 and observing either face 12 of the Tool 1. In the background there is shown an excavator 38 and the excavator bucket 39 removing soil from the left sidewall 33 of the trench 31. The user has placed the lower edge of the left wing 5 and lower edge of the right wing 6 relatively level with the horizon. The slope angles of both the left wing 6 and right wing 6 of the Tool 1 are shown to approximate the slope of the left sidewall 33 and the slope of the right sidewall 32 of the trench 31.

While preferred embodiments of the present inventive concept have been shown and disclosed herein, it will be obvious to those persons skilled in the art that such embodiments are presented by way of example only, and not as a limitation to the scope of the inventive concept. Variations and/or changes, may be suggested to those skilled in the art without departing from the intent, scope, and totality of this inventive concept. Accordingly, it is intended that this inventive concept be inclusive of such variations, changes, and substitutions, and only limited by the scope of the claims presented herein.

What is claimed is:

1. A device for estimating, projecting, and verifying requirements for the slope of sidewalls, depth, distances, and areas associated with the excavation of a trench, such requirements being mandated by a governmental regulating agency, the device comprising:
a handheld planar apparatus comprising a handle connected to a Y-shaped component having a left wing, a right wing, a left upper edge, a left lower edge, a right upper edge, a right lower edge, and further, the Y-shaped component having a first face and a second face, and fabricated to a specific interior angle.

2. A device as in claim 1, farther comprising the imprinting of specific government-mandated regulations and guidelines on both faces of the Y-shaped component of the device.

3. The device set forth in claim 1, wherein the hand-held sighting device contains, on both faces of the Y-shaped component of the device, imprints of:
a) the minimum clearing distance from the left and right shoulders of the trench upon which excavated materials must be placed;
b) the height above the trench which requires a minimum length of a ladder in use must be exposed;
c) the ingress/egress trench at which use of a ladder is mandatory;
d) trench depth at which sloping or shoring of the trench is mandatory;
e) the required slope angle, in degrees, of each of the sidewalls of the trench;
f) the ratio of the height of the trench to its width, as applicable to the type of soil being excavated; and
g) a limitation as to the soil type for which the device may be used.

4. A device for estimating, projecting, and verifying any requirements for the slope of sidewalls, depth, distances, and areas associated with the excavation of a trench, such requirements being mandated by the United States Occupational Safety and Health Administration (OSHA), the device comprising:
a handheld planar apparatus comprising a handle connected to a Y-shaped component having a left wing, a right wing, a left upper edge, a left lower edge, a right upper edge, a right lower edge, and further, the branches of the Y-shaped component fabricated to a specific interior angle.

5. The device set forth in claim 4, wherein the hand-held planar apparatus contains, on both faces of the Y-shaped component, imprints of
a) the minimum clearing distance from the left and right shoulders of the trench upon which excavated materials must be placed;
b) the height above the trench which requires a minimum length of a ladder in use must be exposed:
c) the ingress/egress trench at which use of a ladder is mandatory;
d) trench depth at which sloping or shoring of the trench is mandatory;
e) the required slope angle, in degrees, of each of the sidewalls of the trench;
f) the ratio of the height of the trench to its width, as applicable to the type of soil being excavated; and
g) a limitation as to the soil type for which the device may be used.

6. In circumstances where a construction project requires a trench to be excavated in compliance with certain governmental regulatory standards, including mandatory slope of the trench sidewalls, a method for estimating, projecting, and verifying compliance with the regulatory standards, the method comprising:
providing a hand-held, planar sighting device having a handle, the handle being integrally connected to a Y-shaped component which manifests a first face and a second face;
fabricating the Y-shaped component have an angled left wing, an angled right wing, a left upper edge, a left lower edge, a right upper edge, a right lower edge, and imprints of the regulatory standards on both faces of the Y-shaped component of the device;
requiring that a worker or supervisor at the construction project stand in the bottom of said trench while grasping the handle of said sighting device;
the worker or supervisor holding the sighting device at arm's length while looking lengthwise along a dug-up portion of the trench;
the worker or supervisor superimposing the angle of the left wing and the angle of the right wing of the sighting device onto the left sidewall and right sidewall, respectively, of the trench;
the worker or supervisor making a final determination as to conformance of the trench construction with the applicable governmental standards.

7. The method set forth in claim 6, wherein:
the Y-shaped component of the hand-held sighting device is constructed with left and right wing angles, which correspond to United States OSHA angle/slope requirement for a particular type of soil existing on the construction project.

8. The method set forth in claim 6, wherein:
the Y-shaped component of the hand-held sighting device is constructed with left and right wing angles, which correspond to specific excavation standards of a specific governmental entity, with respect to angle/slope requirement for a particular type of soil existing on a construction project.

9. The method set forth in claim 6, wherein the hand-held sighting device contains, on both faces of the Y-shaped component of the device, imprints of
a) the minimum clearing distance from the left and right shoulders of the trench upon which excavated materials must be placed;
b) the height above the trench which requires a minimum length of a ladder in use must be exposed;
c) the ingress/egress trench at which use of a ladder is mandatory;
d) trench depth at which sloping or shoring of the trench is mandatory;
e) the required slope angle, in degrees, of each of the sidewalls of the trench;
f) the ratio of the height of the trench to its width, as applicable to the type of soil being excavated; and
g) a limitation as to the soil type for which the device may be used.
